(19) United States
(12) Patent Application Publication
(10) Pub. No.: US 2006/0044530 A1
(43) Pub. Date: Mar. 2, 2006

(54) METHOD FOR SIMPLIFYING ON-SCREEN DISPLAY

(76) Inventors: Chien-Wu Yen, Miao-Li County (TW); Tzu-Hai Chung, Miao-Li County (TW); Tung-Lung Lai, Miao-Li County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/904,575

(22) Filed: Nov. 17, 2004

(30) Foreign Application Priority Data
Aug. 30, 2004 (TW) 93125995

(51) Int. Cl. G03B 21/00

(52) U.S. Cl. 353/122

(57) ABSTRACT

A method for simplifying on-screen displays (OSD) suitable for display devices such as projectors is provided. The method mainly comprises the following steps: entering into an edit view from an advanced OSD; selecting one or more desired options; saving the selected options; and displaying a basic OSD based on the selected options. Wherein, both the advanced OSD and the basic OSD include a switch function for switching between each other. This method enables the user to find frequently used options easily, simplifies the operation procedures of the function keys, and still preserves all of the previously existing functions.

### CROSS-REFERENCE TO RELATED APPLICATION

This application claims the priority benefit of Taiwan application serial no. 93125995, filed Aug. 30, 2004.

### BACKGROUND OF THE INVENTION

1. Field of the Invention

The present invention relates to a method for adjusting on-screen displays (OSD), and more particularly, to a method for simplifying OSD.

2. Description of the Related Art

An on-screen display (OSD) is displayed on display devices such as general projectors when a menu key is pressed by a user. Such an OSD includes various options which can be provided to user for adjusting the system configuration, and such options are commonly divided into a plurality of functional groups. For example, the OSD shown in FIG. 1 is divided into six functional groups as follows: Image-I, Image-II, Audio, Language, Management, and Lamp Setting. With a general adjusting method, a left key and/or a right key are pressed first to select a desired functional group. After it is confirmed, an up key and/or a down key are pressed subsequently to select a desired option. Finally, after it is confirmed, the left key and/or the right key are pressed again to adjust the system configuration. Meanwhile, a menu key can be pressed to have the menu go back to the previous directory.

Such method has two disadvantages as follows. The first disadvantage is since there are too many options, it is not easy for user to find out the desired options. The second disadvantage is since the quantity of function keys is not unlimited, the same key may provide different functions in different cases, which may easily confuse users. Therefore, it is required to have a method for simplifying OSD. This method is expected to enable the user to find frequently used options easily, to simplify the operation procedures of the function keys, and to preserve all of the previously existing functions.

### SUMMARY OF THE INVENTION

Therefore, it is an object of the present invention to provide a method for simplifying OSD. This method enables the user to find frequently used options easily, simplifies the operation procedures of the function keys, and still preserves all of the previously existing functions.

In order to achieve the above and other objectives, a method for simplifying OSD is provided by the present invention. The method mainly comprises the following steps: entering into an edit view from an advanced OSD; selecting one or more desired options; saving the selected options; and displaying a basic OSD based on the selected options. Wherein, both the advanced OSD and the basic OSD include a switch function for switching between each other.

In accordance with the preferred embodiment of the present invention, the method for simplifying OSD mentioned above enables the user to find frequently used options in the edit view to compose the basic OSD. Therefore, the OSD can be simplified, and the user can find all of the frequently used options in the same view. In addition, since all operations are performed in the same view, it is neither required to select the functional group, nor to enter to or quit from the multi-layer menu. Accordingly, the usage of the function keys is also simplified. Moreover, both the advanced OSD and the basic OSD include a switch function for switching between each other, such that the user can go back to the advanced OSD view any time to adjust the infrequently used options. Therefore, the integrity of the exiting functions is also preserved.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows an OSD used in the prior art.

FIG. 2 schematically shows an edit view in accordance with an embodiment of the method for simplifying OSD provided by the present invention.

FIG. 3 schematically shows a basic OSD in accordance with an embodiment of the method for simplifying OSD provided by the present invention.

FIG. 4 schematically shows a flow chart illustrating an embodiment of the method for simplifying OSD provided by the present invention.

### DESCRIPTION OF THE PREFERRED EMBODIMENTS

The method for simplifying OSD provided by the present invention is suitable for display devices such as projectors which provide adjustable system configuration options through an on-screen display (OSD). An embodiment is exemplified hereinafter for describing in details the method for simplifying OSD provided by the present invention.

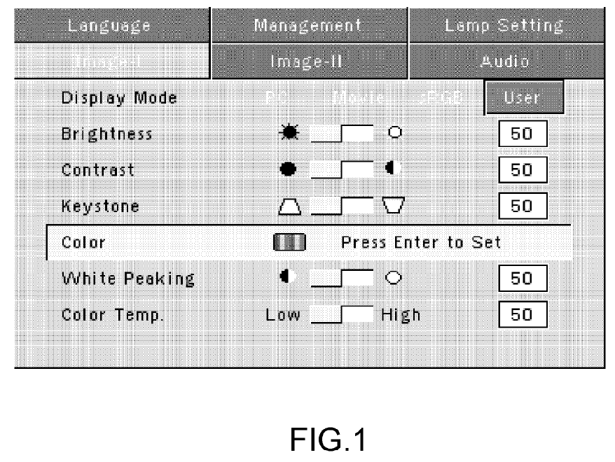

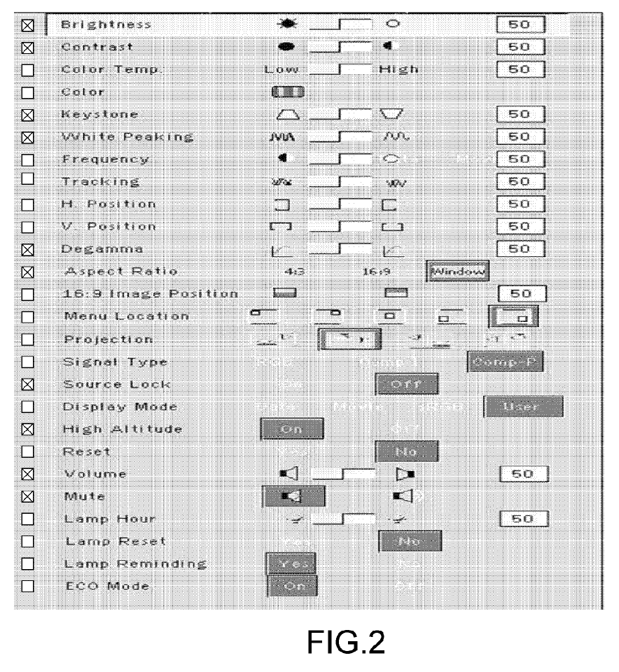

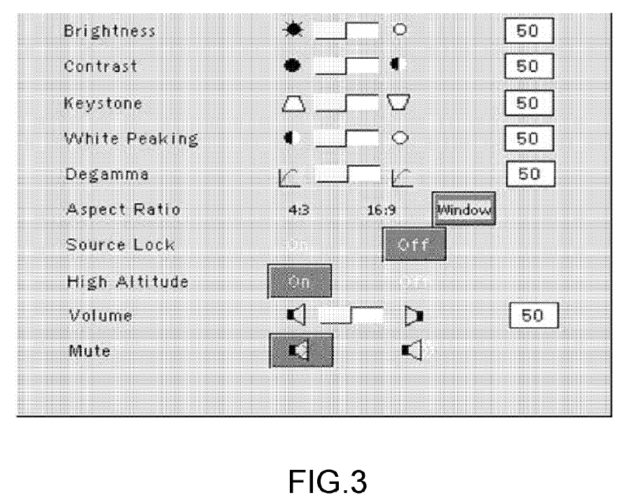

Two types of OSD, that is an advanced OSD and a basic OSD, are provided in the present embodiment. FIG. 1 schematically shows the advanced OSD of the present embodiment. Wherein, the OSD comprises six functional groups as follows: Image-I, Image-II, Audio, Language, Management, and Lamp Setting. These six functional groups include all options. The user can enter into an edit view as shown in FIG. 2 either from the advanced OSD or from the basic OSD. And then the user can select the frequently used options from all of the options provided by the advanced OSD so as to compose the basic OSD as shown in FIG. 3. Since the basic OSD has only one page, it is rather simple to find options and to perform other operations.

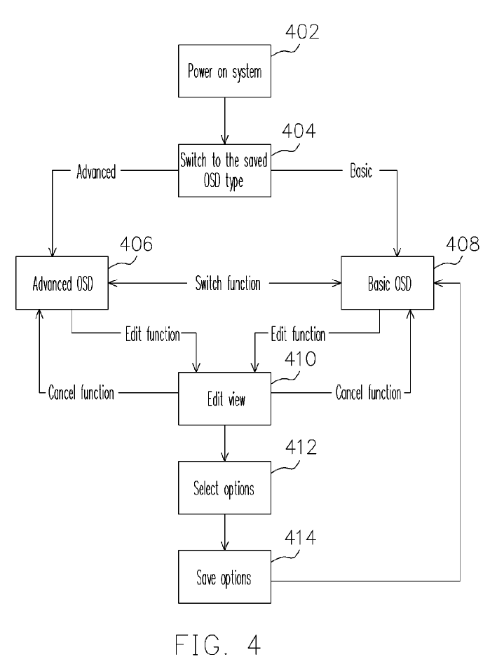

The process flow of the present embodiment is described in great detail with referring to FIG. 4 hereinafter. Fist, in step 402, the system is powered on. Then, in step 404, the system checks and determines the type of the OSD which is previously saved or selected by the user. If it is the advanced OSD, the process goes to step 406, where the advanced OSD is displayed. Otherwise, the process goes to step 408, where the basic OSD is displayed. Wherein, both the advanced OSD and the basic OSD include a switch function for switching between each other. The switch function may be implemented by using a function key or an option. If the switch function is implemented by an option, the switch function provided by the advanced OSD can be included in the management functional group.

Afterwards, the user uses the edit function provided by the advanced OSD or the basic OSD to enter into the edit view in step 410. Wherein the edit function, like the switch function mentioned above, can be implemented by using a function key or an option. If the edit function is implemented by an option, the edit function provided by the advanced OSD can also be included in the management functional group. After entering into the edit view as in step 410, the user selects the options which are desired to be displayed on the basic OSD in step 412, and then saves the options just selected in step 414. Then, the process goes back to step 408 to enter into the basic OSD which has been edited.

In the above process, after entering into the edit view in step 410, if the user change his/her mind, a cancel function can be used to return to the previous advanced OSD or the basic OSD without having to save the selected options. Wherein, the cancel function may also be implemented by using a function key or an option.

Finally, one more function is further provided by the OSD of the present embodiment, it is a function to save the type of the OSD currently selected by the user. With this function, the system is able to switch to the type previously selected by the user automatically in step 404 after power-on.

It is known from the descriptions above, the method for simplifying OSD provided by the present invention enables the user to find frequently used options in the edit view to compose the basic OSD. Therefore, the OSD can be simplified, and the user can find all of the frequently used options in the same view. In addition, since all operations are performed in the same view, it is neither required to select the functional group, nor to enter to or quit from the multi-layer menu. Accordingly, the usage of the function keys is also simplified. Moreover, both the advanced OSD and the basic OSD include a switch function for switching between each other, such that the user can go back to the advanced OSD any time to adjust the infrequently used options. Therefore, the integrity of the existing functions is also preserved.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A method for simplifying on-screen displays (OSD), the method comprising:
entering into an edit view;
selecting one or more desired options;
saving said selected options; and
displaying a basic OSD based on said selected options.

2. The method for simplifying OSD of claim 1, wherein said options of said edit view comprises options for image, audio, language, management, and lamp setting.

3. The method for simplifying OSD of claim 1, wherein said edit view further comprises a cancel function to return to the previous OSD without having to save said selected options.

4. The method for simplifying OSD of claim 1, wherein said edit view is reached from an advanced OSD, and is implemented by an edit function provided by said advanced OSD.

5. The method for simplifying OSD of claim 4, wherein said edit function is included in a management functional group provided by said advanced OSD.

6. The method for simplifying OSD of claim 1, wherein said edit view is reached from said basic OSD.

7. The method for simplifying OSD of claim 6, wherein the reaching of said edit view from said basic OSD is implemented by an edit function provided by said basic OSD.

8. The method for simplifying OSD of claim 1, further comprising an advanced OSD, wherein said advanced OSD comprises a switch function for switching into said basic OSD.

9. The method for simplifying OSD of claim 8, wherein said basic OSD further comprises said switch function for switching into said advanced OSD.

10. The method for simplifying OSD of claim 1, further comprising:
saving the type of the OSD currently displayed; and
switching to said type of the OSD previously saved automatically after power-on.
